(19) United States
(12) Patent Application Publication
(10) Pub. No.: US 2013/0171577 A1
(43) Pub. Date: Jul. 4, 2013

(54) HEATING CONTROL SYSTEM

(71) Applicant: John Bergin, Abbeyleix (IE)

(72) Inventor: John Bergin, Abbeyleix (IE)

(21) Appl. No.: 13/821,177

(22) PCT Filed: Aug. 10, 2011
(86) PCT No.: PCT/EP11/63780

§ 371 Date: Mar. 6, 2013

(30) Foreign Application Priority Data
Sep. 9, 2010 (IE) S2010/0561

(51) Int. Cl. F27D 21/00

(52) U.S. Cl. CPC F27D 21/0014
USPC 432/32

(57) ABSTRACT

A heating control system comprises a vessel including a plurality of fluid ports including: a fluid inlet port arranged to connect to a heated fluid supply, a first controllable radiator circuit port, and a second controllable radiator circuit port. A controller is operatively connected to the controllable radiator circuit ports and to a temperature probe arranged to indicate, in use, a temperature of fluid circulating through the vessel. The controller is arranged to open a selected one of the radiator ports when the probe indicates the fluid is below a temperature T2 and to open the other of the radiator ports when the probe indicates the fluid is above the temperature T2.

This invention relates to a heating control system.

Solid fuel based heating systems can have temperature control problems, which can damage a heating system causing expense to a user for example having to replace radiators due to pitching which is caused when a solid fuel heating system over heats and air enters the system. Additionally crystallisation of calcium occurs when water is heated, the rate at which this crystallisation and hence the build up in pipes occurs is related to the temperature of the water. Controlling water temperature is therefore desirable in hard water areas to prevent build up in the pipes.

Where excessive fuel is fed into a solid fuel heating system, water can get dangerously hot, resulting in continuous expansion of the hot water into an expansion tank. In practice, the expansion tank is made of plastic material and can deform at a high temperature potentially spilling its contents onto occupants of the dwelling. Additionally where there is a high degree of calcium build-up in the pipes of a heating system, or other blockage, there is also the potential for overheated water to become superheated and cause an explosion.

According to the present invention there is provided a heating control system comprising: a) a vessel including a plurality of fluid ports, said fluid ports including: a fluid inlet port arranged to connect to a heated fluid supply, a first controllable radiator circuit port, and a second controllable radiator circuit port; and b) a controller operatively connected to said controllable radiator circuit ports and to a temperature probe arranged to indicate, in use, a temperature of fluid circulating through said vessel, said controller being arranged to open a selected one of said radiator ports when said probe indicates said fluid is below a temperature T2 and to open the other of said radiator ports when said probe indicates said fluid is above said temperature T2.

The invention can prevent pitting in radiators which is occurs when the water overheats and expands into the expansion tank, upon expansion the water level is refreshed by fresh water entering from a reservoir tank. This fresh water has dissolved air which is separated upon heating and allows steam and bubbles to form in the heating system causing pitting. Regular expansion requires regular bleeding of the radiators which in practice does not happen. Pitting in solid fuel systems is a significant issue and requires regular replacement of radiators which is a very costly exercise.

The invention allows for the division of a heating system into zones, so speeding up the heating of radiators in a selected zone by allowing the user to readily pick the desired zone in the house to heat first. When the desired zone reaches a chosen comfortable temperature T2, the second zone automatically opens and the solid fuel appliance heats the second zone.

The invention prevents the water reaching dangerous temperatures.

The invention slows or eliminates the crystallisation of calcium (and other minerals) in the heating system in hard water areas.

Embodiments of the invention provide feedback to the average householder on how much fuel to apply to get full potential out of their boiler in a safe and efficient way. Again, this can provide a significant saving on fuel costs by reducing excessive burning of solid fuels for a required radiator temperature (not employing a room thermostat).

Preferably, said controller comprises a remote control operatively connected to a controller local to said vessel, said remote control including means for selecting said one controllable radiator circuit port.

Preferably, said remote control includes an indicator and is responsive to said fluid reaching a temperature T1 less than T2 to actuate said indicator.

Preferably, said vessel includes a further controllable port in fluid communication with a second port via a coil disposed internally of said vessel, one of said ports being arranged to connect to a pressurized cold water supply and the other of said ports being arranged to connect to a waste, said controller being responsive to said fluid reaching a temperature T3 greater than T2 to open said further controllable port to channel cold water through said vessel to cool fluid in said vessel.

Preferably, said remote control includes a further indicator and is responsive to said fluid reaching said temperature T3 to actuate said indicator.

Preferably, said vessel includes one or more of a pressure indicator, an air valve and a safety valve.

Preferably, said vessel further includes a fluid outlet arranged to allow heated fluid from said vessel to flow to a hot water cylinder.

Preferably, said fluid inlet and said fluid outlet are disposed at opposite corners of said vessel, said fluid outlet being disposed above said fluid inlet.

Embodiments of the invention can prevent the heating system from reaching dangerous temperatures thus preventing scalding and reducing fuel costs through unnecessary burning of fuel.

Embodiments of the invention are useful with larger more powerful solid fuel appliances, where when the second zone reaches a desired comfortable temperature, it is prevented from reaching a dangerous higher temperature. Instead it is cooled gradually, keeping it at a safe temperature for the heating system.

Embodiments of the invention include two indicator lights. The first indicates to the user that enough fuel has been applied. The second warning light tells the user that too much fuel has been applied, the system is too hot, wasting fuel and is now being cooled automatically.

Embodiments of the invention can be installed to both new buildings and readily retro-fitted to existing heating systems.

Embodiments of the invention will now be described with reference to the accompanying drawings, in which:

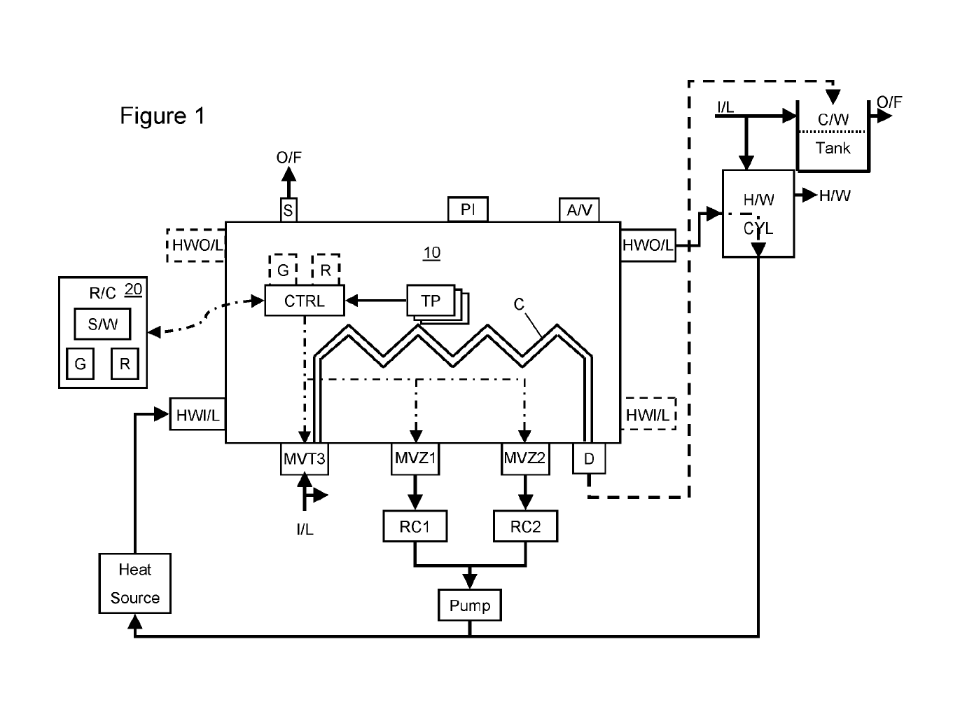

FIG. 1 is a schematic diagram of a heating circuit including a heating control system comprising a heating control vessel and remote controller; and

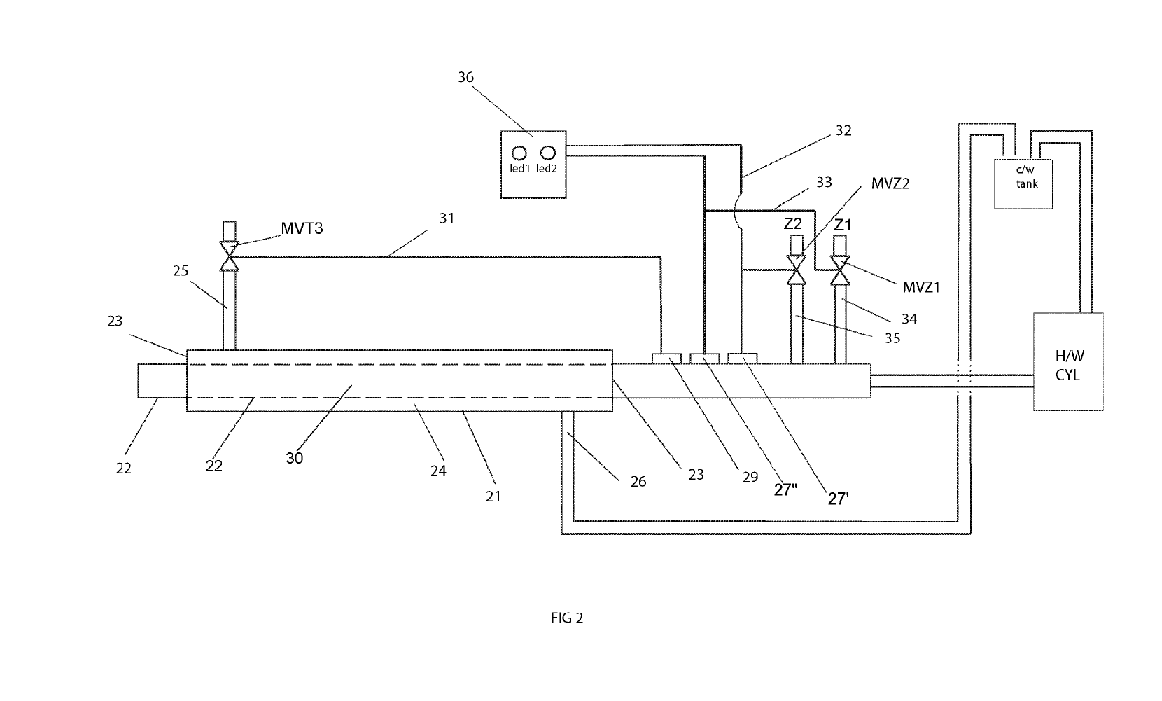

FIG. 2 is a schematic diagram of a second embodiment of the invention.

In the embodiment of FIG. 1, a vessel 10 comprises a sealed tank with dimensions of approximately 600 mm (W)×300 mm (H)×100 mm (D) and contains approximately 18 litres of water (or indeed any suitable heating fluid). Such a tank would be suitable for domestic applications and it will be appreciated that the volume of the vessel could be varied as appropriate. The tank can be fabricated from any suitable material including metals such as copper or aluminium or temperature resistant plastics materials and may in turn be insulated by any suitable material.

The vessel 10 includes a number of ports providing for fluid communication with the remainder of the heating circuit and their function will be described below.

With the vessel installed, a hot water inlet (HWI/L) port is located at the bottom corner of the vessel. The HWI/L port is connected to a hot water source such as a solid fuel stove, range or back boiler, however, it could also be connected to a gas or oil burner or the like. A hot water outlet (HWO/L) port is located at the opposite top corner of the vessel and hot water rising through the vessel exits this port to a hot water cylinder (H/W Cyl) through which it circulates to heat a hot water supply (H/W) for the building. Water returns from the hot water cylinder to the heat source under gravity. In some embodiments of the invention, an alternative pair of HWI/L and HWO/L (shown dashed) ports can be provided at opposite corners of the vessel to facilitate installation of the vessel where feed pipes have different orientations relative to the vessel.

Two motorised valve ports MVZ1 and MVZ2 are disposed towards the bottom of the vessel. At least one of these valves will be open at any given time in accordance with the temperature of the water circulating through the vessel and according to the state of a controller (CTRL). Each of the MVZ1 and MVZ2 ports are connected to respective radiator circuits RC1 and RC2. The radiator circuits are in turn connected back to the heat source via a pump which circulates water around the system according to the state of the valve ports.

In one embodiment of the invention, a temperature probe TP is connected to the controller CTRL to provide a measurement of the temperature of water in the vessel 10. In this embodiment, the controller is in communication with a remote controller (R/C) 20. The remote controller 20 is preferably located for ease of access in a building being heated, whereas the vessel itself is most likely (although not necessarily) to be located at a point not readily visible or accessible to users. In its simplest form, the controller 20 includes a switch (S/W) for selecting between radiator circuits RC1 and RC2 and it includes a pair of indicators G and R whose function will be explained below. These G and R indicators can also be duplicated at the vessel controller CTRL as shown dashed.

In the embodiment, a number of temperature thresholds are set T1<T2<T3<100° C. Typically T1 is approximately 50° C., T2 approximately 60° C.-80° C. and T3 approximately 90° C. When the measured temperature of the water in the vessel reaches T1, the controller switches on indicator G (if present) and signals to the remote controller 20 switch on its indicator G. This signals to a user that the temperature of the water in the zone selected according to the switch (S/W) is approaching optimal and that supply of fuel to the heat source can now be choked. So, for example, a damper can be closed or fuel supply can be slowed or stopped. As such, the controller 20 and its indicators might usefully be located close to the heat source or at least where they can be readily viewed by a user controlling the heat source.

When the temperature of the water in the vessel reaches T2, the second of the motorized valves MVZ1 or MVZ2 opens to allow water to circulate through the other radiator circuit and to bring the water in that circuit up to temperature.

It will of course be seen, that any number of radiator circuits could be selected to be successively or selectively heated once higher priority circuits have come up to temperature. However, in this simplest of implementations, the radiators within a premises are divided into two zones, upstairs/downstairs or bedrooms/living rooms, with one or other being efficiently and selectively heated before the other. Where an existing building has been plumbed with a single radiator circuit, it will be seen that this can be relatively simply split into two, between radiators designated RC1 and radiators RC2, with RC1 being reconnected back to the pump and RC2 being fed from the MVZ2 port.

In a particular embodiment, a further motorized valve port MVT3 and a drain port D are provided. MVT3 and D are connected internally within the vessel by a coil C. MVT3 is connected to a mains water supply (I/L), whereas the drain port D can be connected either directly to waste; or, as shown in the illustrated system, to a secondary inlet of a cold water tank (C/W Tank). The cold water tank is additionally fed with a normal mains supply (I/L) and the level of water in the tank (shown dashed) is controlled by a ballcock (not shown). When plumbed as shown, the ballcock would preferably be set to keep the level of water in the tank relatively low vis-à-vis the overflow (O/F).

When the temperature of water in the vessel 10 reaches T3, MVT3 is opened and water under mains pressure is forced through the vessel to cool the water in the vessel and maintain the temperature of the water below this undesirable temperature level where it is damaging the fabric of the system and wasting energy. If temperature T3 is reached, the controller CTRL switches off the G indicator and switches on the R indicator as well as indicating to the remote controller 20 to do the same with its indicators. This indicates to a user that the system is overheating and that the heat source should be switched off as much as possible. It will be seen that if this state persists for more than a threshold time, the cold tank (C/W Tank) will fill to the extent that water will overflow through (O/F) to waste.

In addition to the ports described above, the vessel can also include a safety valve (S) which drains water from the system in the event of excess pressure, for example, >3 bar. A pressure indicator (PI) can also be provided and this can simply display pressure locally, or alternatively provide a signal to the controller CTRL, which can in turn relay the pressure measured to the remote controller 20 where it could be displayed.

Finally, an air valve (NV) can be provided to allow air to bleed from the system.

In the simplest implementations of the invention, the controller CTRL can be mains powered and hardwired through switched wires to the remote controller 20 which includes a double pole switch for switching between MVZ1 and MVZ2. Three mains rated temperature probes could then be located in the vessel, set with their respective temperatures (T1 indicating optimal temperature, T2 for opening the second zone and T3 indicating overheating), and connected through the controller CTRL to switch R and G mains bulbs and the motorized valves MVZ1, MVZ2 and MVT3 as described above. In this case, the remote controller would not need a separate power supply as it is simply providing an open or closed contact back to the vessel controller (CTRL) and equally the bulbs R and G are simply in circuit with temperature probes T3 and T1 respectively. Preferably, T3 would be wired to switch off indicator G when indicator R switches on.

On the other hand, the controller CTRL and remote controller 20, could be digital, the remote controller perhaps having a display, keypad, LED R and G indicators and even a sounder/buzzer. The controller CTRL and remote controller could be connected by any suitable communications bus or even wirelessly. Here, a single temperate probe such as TP in the figure could enable CTRL to provide a temperature measurement to the remote controller with the remote controller providing switching commands for each of the valves MVZ1, MVZ2 and MVT3 and indeed local R and G indicators and being programmable by a user as required. For example, with a timer, the remote controller could enable a user to select bedrooms as the preferred zone in the mornings with downstairs being selected as the preferred zone in the evenings or any variant thereof.

In a second embodiment of the invention, FIG. 2, instead of the cooling circuit passing through the vessel as in the first embodiment, it surrounds a portion of the hot water circuit. In this embodiment, the vessel thus comprises a sleeve 21 surrounding a hot water pipe 22. The sleeve 21 has ends 23 which provide a water and pressure tight chamber 24 which is accessed by a cold water inlet 25 and outlet 26. Variable normally open thermostats 27′ and 27″ and a fixed normally open thermostat 29 are attached to the pipe 22 and motorised valve ports MVT3, MVZ1 and MVZ2 are located on the cold water inlet 25 and on zones Z1 and Z2. Outputs from the thermostats 27′, 27″, 29 are connected to their respective valve ports MVZ2, MVZ1, MVT3 as shown in FIG. 2. When a thermostat reaches its preset trigger temperature the respective valve opens to close when the temperature falls below the preset temp. Control lines are also provided from the thermostats 27′ and 27″ to a set of indicator lamps LED 1 and LED 2 in a housing 36. The LED 1 being lit when thermostat 27′ is closed and LED 2 being open when thermostat 27″ is closed.

The range of the variable thermostats will in practice be circa 40 deg C. to 70 deg C. The temperature that is set on each thermostat will determine when the related zone is opened. To ensure a zone is heated first, its related thermostat should be set to the lower temperature, T1, e.g. 40 deg C. The second zone will only open when the higher temperature T2 is reached which will be greater than 40 deg C.

In practice, the user fuels the fire and the water temperature within the pipe 22 rises so in turn heating fluid within the sleeve 23. Upon the temperature of the water reaching the lowest threshold temperature of either variable thermostats 27′ and 27″ controlling zones 1 and 2 the relevant motorised valve MVZ1 or MVZ2 will open thereby heating that zone. The relevant LED indicating that zone has reached temperature will light up. Upon the system heating further with further burning of the fuel, the thermostat set at the higher temperature T2 will open thereby opening the second zone and lighting the second LED. In the event that excessive fuel is added and the water in the system continues to heat up to a dangerous level the fixed thermostat 29 opens valve MVT3 which facilitates unheated water from the mains or a tank (not shown) entering the chamber 24 thus cooling the hot water in pipe 22. This ensures that the water does not reach dangerous temperatures which may cause scalding, and the water to enter the expansion tank which causes pitting. In practice the triggering temperature T3 for the fixed thermostat would be set at 80 deg C.

The cooling circuit 25, 23, 26 of the second embodiment is very economical to produce, small in size, quick to install and practical for installation in a hot press where there is generally good access to the plumbing for each zone.

While three thermostats are shown it will be appreciated that a single temperature probe with control circuitry to control the valves in the manner described could be employed. It will also be appreciated that the number of thermostats may vary, indeed a thermostat may be employed solely for the purposes of lighting the LEDs as described.

While the thermostats have been described as being normally open it will be appreciated that they could be normally closed with the appropriate circuitry to enable the opening of the motorised valves on the selected temperature being reached.

Also, while certain thermostats have been described as being variable or fixed it will be appreciated that this may vary.

While control lines have been shown for the LEDs 1 and 2 it will be appreciated that this connection may be implemented in any suitable fashion including wirelessly to locate the housing 36 as desired by a user.

In the second embodiment, LED 1 is described as lighting when Zone 1 is open and LED 2 lights when Zone 2 is operational. In variants of this embodiment, the thermostat 29 can also be connected to the housing 36 to have an LED (preferably red) light when the temperature T3 is reached. Also, a single LED (preferably green) can be used instead of LEDs 1 and 2 and this can be connected to light when either of radiator zone 1 or 2 first operates, to indicate that the stove has brought the heating fluid up to temperature.

Ideally the vessel should be installed close to the stove to ensure the maximum temperature is not exceeded. In any case, calibration of the system may be required to take into account cooling of the water between the stove and the thermostats especially in areas of hard water where mineral build-up is an issue.

The invention allows for an improved distribution of heat throughout a building for a given amount of fuel. The invention helps to maintain radiators at a constant temperature while minimising the amount of fuel required to do the same.

The invention can prevent pitting as water is cooled rather than introducing new water with a high degree of dissolved oxygen.

Embodiments of the invention allow for safer operation of solid fuel appliances employing back boilers and provide the advantage of having three separate thermostats. This provides triple redundancy in the event that any one fails thus preventing scalding as described heretofore. The last resort is the expansion tank. Where the invention is employed in areas of hard water and the trigger temperature of the thermostat 29 is set low, this will minimise the rate of mineral build up in the system.

The invention could be provided as a retrofit to existing heating systems or be integral to a heating appliance.

Its use, the invention is not limited to solid fuel heating systems but may be employed where the heating of fluid is not well controlled such as solar panel heating.

The invention is not limited to the embodiment(s) described herein but can be amended or modified without departing from the scope of the present invention.

1. A heating control system comprising:
a) a vessel including a plurality of fluid ports, said fluid ports including: a fluid inlet port arranged to connect to a heated fluid supply, a first controllable radiator circuit port, and a second separately controllable radiator circuit port; and
b) a controller operatively connected to said controllable radiator circuit ports and to a temperature probe arranged to indicate, in use, a temperature of fluid circulating through said vessel, said controller being arranged to open only a selected one of said radiator ports when said probe indicates said fluid is below a temperature T2 and to open both of said radiator ports when said probe indicates said fluid is above said temperature T2.

2. A heating control system according to claim 1 in which the system is divided into two zones, each zone comprising a set of radiators and being connected to a respective one of said radiator circuit ports, so that when fluid in a first zone reaches the temperature T2, the second zone automatically opens and fluid in the second zone is heated.

3. A heating control system as claimed in claim 1 arranged to provide feedback to a user on fuel consumption for a heating system including said heating control system.

4. A heating control system as claimed in claim 1 wherein said controller comprises a remote control operatively connected to a controller local to said vessel, said remote control including means for selecting said one controllable radiator circuit port.

5. A heating control system as claimed in claim 4, wherein said remote control includes an indicator and is responsive to said fluid reaching a temperature T1 less than T2 to actuate said indicator.

6. A heating control system as claimed in claim 1 wherein said vessel includes a further controllable port in fluid communication with a second port via a coil disposed internally of said vessel, one of said ports being arranged to connect to a pressurized cold water supply and the other of said ports being arranged to connect to a waste, said controller being responsive to said fluid reaching a temperature T3 greater than T2 to open said further controllable port to channel cold water through said vessel to cool fluid in said vessel.

7. A heating control system as claimed in claim 4, wherein said remote control includes an indicator which is responsive to said fluid reaching a temperature T3 greater than T2 to actuate said indicator.

8. A heating control system as claimed in claim 1, wherein said vessel includes one or more of a pressure indicator, an air valve and a safety valve.

9. A heating control system as claimed in claim 1, wherein said vessel further includes a fluid outlet arranged to allow heated fluid from said vessel to flow to a hot water cylinder.

10. A heating control system as claimed in claim 9, wherein said fluid inlet and said fluid outlet are disposed at opposite corners of said vessel, said fluid outlet being disposed above said fluid inlet.

11. A heating control system as claimed in claim 6, including two indicators, a first indicating to a user that enough fuel has been applied to a heating system including said heating control system and a second indicating to the user that the heating system is being cooled automatically.
